(19) United States
(12) Patent Application Publication
(10) Pub. No.: US 2016/0102207 A1
(43) Pub. Date: Apr. 14, 2016

(54) PREMIX COMPOSITION FOR BITUMENS

(71) Applicant: ARKEMA FRANCE, Colombes, OT (FR)

(72) Inventors: Vincent Palluault, Evreux (FR); Sebastien Quinebeche, Bernay (FR)

(73) Assignee: ARKEMA FRANCE, Colombes, OT (FR)

(21) Appl. No.: 14/786,935

(22) PCT Filed: Apr. 18, 2014
(86) PCT No.: PCT/FR2014/050949

§ 371 Date: Oct. 23, 2015

(30) Foreign Application Priority Data
Apr. 25, 2013 (FR) 1353782

(51) Int. Cl. C08L 95/00; C08L 23/08

(52) U.S. Cl. CPC C08L 95/00; C08L 23/0884; C08L 23/0869; C08L 2205/02; C08L 2205/03; C08L 2555/80

(57) ABSTRACT

A premix composition for bitumens, including: from 35% to 65%, by weight of the composition, of bitumen, from 5% to 65%, by weight of the composition, of a first copolymer of an alpha-olefin and of an unsaturated carboxylic acid ester, characterized in that it additionally includes from 5% to 65% by weight of a second copolymer of an alpha-olefin, an unsaturated epoxide and an unsaturated carboxylic acid ester and in that the aforesaid first copolymer and the aforesaid second copolymer represent between 35% and 65% by weight of said composition. Also, a bituminous mix including this composition and also the use of this composition for the preparation of such a mix.

### FIELD OF THE INVENTION

The invention belongs to the field of bituminous mixes and more specifically to technologies relating to functional additives added to the mixture of bitumen and aggregates in order to give it particular physicochemical and mechanical properties. More specifically, the invention relates to a premix composition that can be used directly for being dispersed in the mixture of bitumen and aggregates in order to give it the desired properties.

The invention also relates to a bituminous mix comprising a predetermined proportion (range of concentration in the mixture of bitumen and aggregates, by relative weight) of the aforesaid premix and also to the use of this premix for obtaining a bituminous mix.

### PRIOR ART

The use of bitumen in the manufacture of materials for road and industrial applications has been known for a long time: bitumen is the main hydrocarbon-based binder used in the field of road construction or civil engineering.

Bitumen or asphalt is the heaviest portion in the petroleum distillation process. Due to the various origins and distillation processes of such petroleums, the resulting bitumen may have a wide range of properties and characteristics. In the present invention, bitumen denotes not only the product of petroleum by direct distillation or the distillation of petroleum at reduced pressures, but also the products originating from the extraction of tar and bituminous sands, the products of oxidation and/or fluxing with carbon solvents comprising paraffins and waxes of such bituminous materials, and also blown or semi-blown bitumens, synthetic bitumens (such as those described for example in FR-A-2853647), tars, petroleum resins or indene-coumarone resins mixed with aromatic and/or paraffinic hydrocarbons and mixtures thereof, and mixtures of such bituminous materials with acids, etc.

The main application for bitumen is in mixes (bituminous mixes), in which the bitumen is mixed with aggregates that may be of various sizes, shapes and chemical natures. These bituminous mixes are used in particular for the construction, repair and maintenance of sidewalks, roads, highways, parking lots or airport runways and service roads and any other running surface. In the present invention, the aggregates comprise in particular, but not exclusively, the mineral aggregates that are the product of quarries and also aggregates recovered from previous mixes (“Reclaimed Asphalt Pavement”, RAP), as described for example in the AFNOR XP P98-135 standard, December 2001, Asphalt Handbook, MS-4 7^{th} edition, published by the Asphalt Institute, USA), products from the demolition of buildings and mixtures thereof and also organic and inorganic fibers, such as glass fibers, metal fibers or carbon fibers, and also cellulose fibers, cotton fibers, polypropylene fibers, polyester fibers, polyvinyl alcohol fibers and polyamide fibers.

The use of bitumen in the manufacture of materials for road and industrial applications has been known for a long time: bitumen is the main hydrocarbon-based binder (for binding the aggregates together) used in the field of road construction or civil engineering. In order to be able to be used as a binder in these various applications, the bitumen must have certain physicochemical properties. One of the most important properties is the hardness of the bitumen; this must be, at the usage temperatures, high enough to prevent the formation of ruts caused by the traffic. Another very important feature is the viscosity of the bitumen; the bitumen must be sufficiently fluid at the lowest possible application temperatures.

One means for hardening a bitumen is to blow it. Blown bitumens are manufactured in a blowing unit, by passing a stream of air and/or oxygen through a starting bitumen. This thermal oxidation operation may be carried out in the presence of an oxidation catalyst, for example phosphoric acid. Generally, the blowing is carried out at high temperatures, of the order of 200 to 300° C., for relatively long periods, typically of between 30 minutes and 2 hours, in continuous or batch mode. This blowing process has a certain number of drawbacks that very often make this technique unacceptable.

Another means for hardening a bitumen, or for modifying its mechanical properties, consists in adding polymers thereto. These polymers make it possible in particular to improve the cohesion of the binder, to improve the elastic properties of the binder, to increase the plasticity range of the bitumen, to increase the resistance to deformation and also to increase the hardness of the bitumen by decreasing its penetrability and its thermal susceptibility and also the improvement in its rheological properties. At the usage temperatures, these features are therefore substantially improved, which will have the effect of reducing or even eliminating the risks of cracking and rutting, which results in very significantly reduced upkeep and maintenance costs. Moreover, owing to this polymer modification, it is possible to use much thinner road strips than with unmodified bitumen, while at the same time having better mechanical performance.

Currently, the standard technology for introducing these polymer additives follows the following steps. Firstly, in a first step, the polymer additives are added to all, or almost all, of the bitumen necessary to produce the “final” bituminous mix, which constitutes a mixture identified as “modified bitumen” or “binder”, then in the second step, the aggregates, optionally with additional bitumen, are added to this modified bitumen in order to form the bituminous mix.

This technique is not satisfactory. It imperatively requires two steps to arrive at the bituminous mix which not only takes a relatively long preparation time but also requires expensive facilities. Furthermore, this technique has the major drawback of not allowing the preparation in situ, as close as possible to the requirements of the operators, of the bituminous mix to be applied, so that the latter, having already been previously prepared, is capable of exhibiting degraded performance (hardening by thermo-oxidative aging, separation and segregation of the polymer and bitumen phases, increase in viscosity).

Recently, a technique that is completely different in its process for preparing the bituminous mix has appeared. It aims to overcome the drawbacks of the above-mentioned preparation technique by enabling a preparation of the bituminous mix in a single step, furthermore which is in situ, that is to say on the site of mixing the aggregates with the bituminous binder. This technique for preparing the bituminous mix consists in producing a premix that combines bitumen with a certain amount of one or more polymers. This premix is supplied to the operators who themselves produce, depending on the characteristic features of their requirements on the ground, the bituminous mix by adding this premix to bitumen and aggregates.

Currently, the use of ECB (“Ethylene Copolymer Bitumen”, combination of a bitumen with a copolymer of Evatane® ou Lotryl® type), polyethylene (PE) and polypropylene (PP) polymers is known for these premix compositions but they are not completely satisfactory both from the point of view of the mechanical properties of the bituminous binder, in particular the elastic recovery, and also the thermal susceptibility (plasticity range).

The use is also known of a terpolymer of ethylene/(meth)acrylate/glycidyl (meth)acrylate type that makes it possible to improve the elastic recovery and thermal susceptibility properties, but it is also known that this type of polymer, reacting with bitumen, is very difficult to use at more than five percent (5%) in the bitumen without seeing the appearance of the bitumen deteriorate due to the appearance of gels (U.S. Pat. No. 5,306,750).

Documents U.S. Pat. No. 6,020,404, WO 2006/107907 and US 2004/0198874 are well known, but none of these disclosures proposes the solution that consists in producing a premix of bitumen and particular polymers (in the absence of aggregates, representing at least 90% of the weight of the final bituminous mix) which is subsequently dispersed in an assembly of bitumen and aggregates (final bituminous mix).

### BRIEF DESCRIPTION OF THE INVENTION

Surprisingly, the applicant has discovered, in contradiction with the teachings of the prior art, that it is possible to prepare a premix containing an epoxide functionalized polymer by combining it with a copolymer of an alpha-olefin and of an unsaturated carboxylic acid ester, and by using a thermoplastic mixing tool. Specifically, it was known that an excessively concentrated Lotryl®/Lotader® mixture in bitumen resulted in too high a viscosity and problems of heterogeneity (formation of gels).

Furthermore, since the contents of polymers present in this premix are greater than 35%, the use of this premix is economically viable for the preparation of bituminous mixes in a single step.

The present invention thus relates to a premix composition for bituminous mixes comprising:

from 35% to 65%, by weight of the composition, of bitumen,

from 5% to 65%, by weight of the composition, of a first copolymer (A) of an alpha-olefin and of an unsaturated carboxylic acid ester, characterized in that it additionally comprises from 5% to 65% by weight of a second copolymer (B) of an alpha-olefin, of an unsaturated epoxide and of an unsaturated carboxylic acid ester and in that the aforesaid first copolymer (A) and the aforesaid second copolymer (B) represent between 35% and 65% by weight of said composition.

According to a possibility that can be envisaged with the present invention, the premix composition will consist solely of the aforementioned three elements, namely the bitumen and the first and second copolymers.

Other features and embodiments of the invention are presented hereinbelow:

advantageously, the weight ratio of (B)/[(A)+(B)] is between 0.15 and 0.5, preferably between 0.25 and 0.35;

the composition according to the invention consists of bitumen and the first and second aforesaid copolymers;

according to one advantageous aspect of the invention, the alpha-olefin of the aforesaid first and second copolymers (A) and (B) consists of an ethylene, propylene, 1-butene, isobutene, 1-pentene, 1-hexene, 1-decene, 4-methyl-1-butene, 4,4-dimethyl-1-pentene, vinylcyclohexane, styrene, methylstyrene or alkyl-substituted styrene group, and preferably of ethylene;

according to another advantageous aspect of the invention, the unsaturated carboxylic acid ester of the aforesaid first and second copolymers (A) and (B) consists of an alkyl (meth)acrylate, the alkyl group comprising up to 24 carbon atoms;

according to yet another advantageous aspect of the invention, the unsaturated epoxide of the copolymer (B) consists of an aliphatic glycidyl ester/ether or of an alicyclic glycidyl ester/ether;

according to one preferred embodiment of the invention, the second copolymer (B) is an ethylene/alkyl (meth)acrylate/glycidyl (meth)acrylate copolymer, having from 0.1% to 65% by weight of alkyl (meth)acrylate, the alkyl of which comprises from 1 to 10 carbons, and up to 12% by weight of glycidyl (meth)acrylate;

according to one preferred embodiment of the invention, the first copolymer (A) is an ethylene/alkyl (meth)acrylate copolymer, the alkyl of which comprises from 1 to 10 carbons, and up to 65% by weight of (meth)acrylate.

The invention has in particular the advantages of being able to be used in situ, without any deterioration of the bituminous mix and with an economic saving (application time, labor, amount of bituminous mix corresponding to the actual requirement).

The present invention also relates to a bituminous mix comprising aggregates and bitumen, characterized in that it comprises a premix composition as defined above. Preferably, said premix composition is present between 1% and 15% by weight, preferably between 3% and 8%, in the bituminous mix.

Finally, the invention relates to the use of the aforesaid composition for the preparation of a bituminous mix.

The following description is given solely by way of illustration and non-limitingly.

### DETAILED DESCRIPTION OF THE INVENTION

Regarding the bitumen, this element may consist of any element that comes under the definition or under the designation of bitumen such as a person skilled in the art may understand it without undue effort.

Regarding the second copolymer (B), it is a copolymer of an alpha-olefin comprising at least one unsaturated epoxide and at least one unsaturated carboxylic acid ester.

The unsaturated epoxide may be selected from:

aliphatic glycidyl esters and ethers such as allyl glycidyl ether, vinyl glycidyl ether, glycidyl maleate and glycidyl itaconate, glycidyl acrylate and glycidyl methacrylate, and

alicyclic glycidyl esters and ethers such as 2-cyclohexene-1-glycidyl ether, glycidyl cyclohexene-4,5-dicarboxylate, glycidyl cyclohexene-4-carboxylate, glycidyl 5-norbornene-2-methyl-2-carboxylate and diglycidyl endo-cis-bicyclo[2.2.1]-5-heptene-2,3-dicarboxylate.

Advantageously, glycidyl (meth)acrylate is used.

The unsaturated carboxylic acid ester may be, for example, an alkyl (meth)acrylate, the alkyl group possibly having up to 24 carbon atoms.

Examples of alkyl acrylates (or methacrylates) that can be used are in particular methyl acrylate, ethyl acrylate, n-butyl acrylate, isobutyl acrylate and 2-ethylhexyl acrylate.

The alpha-olefin may be ethylene, propylene, 1-butene, isobutene, 1-pentene, 1-hexene, 1-decene, 4-methyl-1-butene, 4,4-dimethyl-1-pentene, vinylcyclohexane, styrene, methylstyrene or alkyl-substituted styrene. Advantageously, ethylene is used.

The unsaturated epoxide may be grafted or copolymerized with the alpha-olefin and the unsaturated carboxylic acid ester. Copolymerization is preferred.

Advantageously, (B) is an ethylene/alkyl (meth)acrylate, the alkyl of which has from 1 to 10 carbons/glycidyl (meth)acrylate copolymer and that contains up to 65% by weight of (meth)acrylate and up to 12% by weight of epoxide.

Regarding the first copolymer (A), it is a copolymer of an alpha-olefin comprising at least one unsaturated carboxylic acid ester. The alpha-olefin and the unsaturated carboxylic acid ester may be selected from the same products already cited above for the copolymer (B).

Advantageously, (A) is an ethylene/alkyl (meth)acrylate copolymer, the alkyl of which has from 1 to 10 carbon atoms, and that contains up to 65% by weight of (meth)acrylate.

The premix according to the invention is produced according to a one-step process during which the ingredients are mixed to give a homogeneous composition and to carry out the optional chemical reactions between components. This premix may be prepared by mixing the various constituents by conventional thermoplastic processing means, such as for example extrusion or kneading. It is possible to use an internal mixer, a co-kneader or a co-rotating twin-screw extruder. Preferably, compositions are produced at a temperature between 100 and 300° C.

### Obtaining the Formulations of the Compositions Tested:

Although the premix according to the invention is used during the aggregate mixing step, its characterization is carried out by a dilution in unmodified bitumen in order to form a binder having a composition equivalent to that obtained during the aggregate mixing step. Specifically, the elastic recovery and viscosity properties are conventionally measured on the binder and not on the bituminous mix.

The premixes were prepared using a Brabender® Plastograph internal mixer at a temperature of 160° C. and a rotational speed of the rotors of 60 rpm (revolutions per minute). The polymers are firstly introduced in order to be melted and intimately mixed. The bitumen is then introduced into the internal mixer after having been preheated to 150° C. The addition of the bitumen must be quite slow (several minutes) in order to enable a good incorporation into the mixture of polymers. The mixing time after introduction of all the components is ten (10) minutes.

The binders were prepared in a reactor maintained at 160° C. and equipped with a mechanical stirring system by mixing 25 g of premix and 475 g of bitumen with no additives. The amount of premix used therefore represents 5% of the binder thus obtained. The stirring speed is 400 rpm and the mixing time is 2 hours. The binder then undergoes a heat treatment for 24 h (one whole day) at 190° C. before evaluating these elastic recovery and viscosity properties.

### Tests Performed:

Viscosity Test

Viscosity measurements are carried out using a viscometer of “Brookfield Viscometer” type. The measurement device used is a Brookfield® DVIII viscometer. The principle of the measurement is based on the measurement of the torque (proportional to the shear stress) needed to keep constant the rotational angular velocity (proportional to the shear rate) of a spindle immersed in the modified bitumen, and to deduce proportionally therefrom the viscosity of the latter.

The measurement is carried out using an SC4-21 spindle (ISO 2555 standard). Between 5 and 10 ml (milliliters) of modified bitumen are introduced into the measurement chamber maintained at 135° C. The values given in the examples below correspond to a rotational velocity of the spindle of 20 rpm and are expressed in mPa·s (milliPascal seconds). The accuracy of the measurement is ±10% of the value indicated.

### Elastic Recovery Test

The elastic recovery of a modified bitumen is an indicator that makes it possible to characterize the ability of the binder to regain its original geometric characteristics following a deformation. It is determined with the aid of a laboratory test using an apparatus similar to that of the ductility test and the force-ductility test, apparatus commonly referred to as a “ductilometer”. The measurement device used is a Frowag® type 1.723 ductilometer.

The measurement takes place as described below according to the NF EN 13398 standard. After thermal equilibrium of the test specimens placed in the apparatus (30 minutes in a thermostatic water bath at 25° C.), these test specimens are stretched at 50 mm/min (millimeters per minute) in order to undergo an elongation of 200 mm. In the 10 seconds following the end of the stretching, the test specimens are then cut in the middle and the length of shrinkage of the test specimens is measured after 30 minutes. The value of the elastic recovery is the percentage shrinkage length of the test specimen relative to its total length. An elastic recovery ratio of 100% corresponds to a binder that completely recovers its original dimensions (before stretching).

### Raw Materials of the Compositions Tested:

The bitumen used is a bitumen having a penetrability, determined according to the methods of the NF EN1426 standard, within the range of 50/70.

Lotader® AX8900: terpolymer of ethylene, methyl acrylate (24 wt %) and glycidyl methacrylate (8 wt %) produced by ARKEMA having an MFI (190° C., 2.16 kg measured according to ISO 1133) of 6 g/10 min.

Lotryl® 17BA07: copolymer of ethylene and butyl acrylate (17 wt %) produced by ARKEMA having an MFI (190° C., 2.16 kg measured according to ISO 1133) of 7 g/10 min.

### Results of the Tests:

The bituminous binder should have certain advantageous characteristics.

Reported here, non-exhaustively, are the results relating to a bituminous binder obtained from the premix according to the present invention. Within this context, three characteristics have been more particularly targeted, namely:
the viscosity at 135° C. of the bituminous binder, which should ideally be less than 3000 mPa·s; and
the elastic recovery (%) which should be greater than 60% and preferably greater than 70%; and finally
the absence of gel (observation with the naked eye) in the bituminous binder.

The table below lists some of the test results obtained by the proprietor. Without prejudice to the interpretation, these results have enabled the proprietor to define the invention as stated in all of the appended claims.

| | Content of | Content of | | | | Viscosity | |
|---|---|---|---|---|---|---|---|
| | Lotryl ® | Lotader ® | | | | at | Elastic |
| | 17BA07 | AX8900 | | (B)/ | Surface | 135° C. | recovery |
| Premix | (A) | (B) | (A) + (B) | [(A) + (B)] | appearance | (mPa · s) | (%) |
| 1 | 50% | 0% | 50% | 0 | Smooth | 1520 | 41 |
| 2 | 45% | 5% | 50% | 0.1 | Smooth | 1850 | 46 |
| 3 | 40% | 10% | 50% | 0.2 | Smooth | 2230 | 63 |
| 4 | 35% | 15% | 50% | 0.3 | Smooth | 2630 | 75 |
| 5 | 30% | 20% | 50% | 0.4 | Smooth | 3090 | 80 |
| 6 | 20% | 30% | 50% | 0.6 | Gelled | 3680 | 82 |
| 7 | 10.5% | 4.5% | 15% | 0.3 | Smooth | 910 | 44 |
| 8 | 17.5% | 7.5% | 25% | 0.3 | Smooth | 1130 | 55 |
| 9 | 21% | 9% | 30% | 0.3 | Smooth | 1550 | 58 |
| 10 | 26.5% | 11.5% | 38% | 0.3 | Smooth | 1790 | 68 |
| 11 | 28% | 12% | 40% | 0.3 | Smooth | 1880 | 72 |
| 12 | 42% | 18% | 60% | 0.3 | Smooth | 2820 | 80 |
| 13 | 49% | 21% | 70% | 0.3 | Gelled | 3460 | 69 |

1. A premix composition for bituminous mixes comprising:
from 35% to 65%, by weight of the composition, of bitumen,
from 5% to 65%, by weight of the composition, of a first copolymer (A) of an alpha-olefin and of an unsaturated carboxylic acid ester, and
from 5% to 65% by weight of a second copolymer (B) of an alpha-olefin, of an unsaturated epoxide and of an unsaturated carboxylic acid ester,
wherein the aforesaid first copolymer (A) and the aforesaid second copolymer (B) represent between 35% and 65% by weight of said composition.

2. The composition as claimed in claim 1, wherein the weight ratio of (B)/[(A)+(B)] is between 0.15 and 0.5.

3. The composition as claimed in claim 1, wherein said composition consists of bitumen and the first and second aforesaid copolymers.

4. The composition as claimed in claim 1, wherein the alpha-olefin of the aforesaid first and second copolymers (A) and (B) consists of an ethylene, propylene, 1-butene, isobutene, 1-pentene, 1-hexene, 1-decene, 4-methyl-1-butene, 4,4-dimethyl-1-pentene, vinylcyclohexane, styrene, methylstyrene or alkyl-substituted styrene group.

5. The composition as claimed in claim 1, wherein the unsaturated carboxylic acid ester of the aforesaid first and second copolymers (A) and (B) consists of an alkyl (meth)acrylate, the alkyl group comprising up to 24 carbon atoms.

6. The composition as claimed in claim 1, wherein the unsaturated epoxide of the copolymer (B) consists of an aliphatic glycidyl ester/ether or of an alicyclic glycidyl ester/ether.

7. The composition as claimed in claim 1, wherein the second copolymer (B) is an ethylene/alkyl (meth)acrylate/glycidyl (meth)acrylate copolymer, having from 0.1% to 65% by weight of alkyl (meth)acrylate, the alkyl of which comprises from 1 to 10 carbons, and up to 12% by weight of glycidyl (meth)acrylate.

8. The composition as claimed in claim 1, wherein the first copolymer (A) is an ethylene/alkyl (meth)acrylate copolymer, the alkyl of which comprises from 1 to 10 carbons, and up to 65% by weight of (meth)acrylate.

9. A bituminous mix, comprising aggregates and bitumen, wherein the bituminous mix comprises a premix composition as claimed in claim 1.

10. The bituminous mix as claimed in claim 9, wherein said premix composition is present between 1% and 15% by weight in the bituminous mix.

11. A method of preparing a bituminous mix, comprising combining aggregates and the premix composition as claimed in claim 1.

12. The composition as claimed in claim 2, wherein the second copolymer (B) is an ethylene/alkyl (meth)acrylate/glycidyl (meth)acrylate copolymer, having from 0.1% to 65% by weight of alkyl (meth)acrylate, the alkyl of which comprises from 1 to 10 carbons, and up to 12% by weight of glycidyl (meth)acrylate, and
wherein the first copolymer (A) is an ethylene/alkyl (meth)acrylate copolymer, the alkyl of which comprises from 1 to 10 carbons, and up to 65% by weight of (meth)acrylate.

13. A method of preparing a bituminous mix, comprising combining aggregates and the premix composition as claimed in claim 12.
